(19) United States
(12) Patent Application Publication
(10) Pub. No.: US 2010/0148446 A1
(43) Pub. Date: Jun. 17, 2010

(54) SEAL ASSEMBLY AND METHOD FOR MAKING AND USING THE SAME

(75) Inventors: SEAN GAUDETTE, KATY, TX (US); BENNETT RICHARD, KINGWOOD, TX (US); Gerald Lynde, Houston, TX (US); Clint Mickey, Spring, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 12/332,969

(22) Filed: Dec. 11, 2008

(51) Int. Cl. F16J 15/32

(52) U.S. Cl. 277/307; 277/575

(57) ABSTRACT

A seal assembly including a seal body; an augmentation configuration partially radially displaced from the seal body; a filler material at least partially disposed between the seal body and the augmentation configuration and method.

### BACKGROUND

As is well appreciated by anyone involved in a downhole production industry such as for the production of hydrocarbons, sealing is a necessary and ubiquitous issue. Since for all downhole operations are affected by conditions generated naturally, sealing issues and thus seal parameters can be very different from each other. For this reason among others, many different types of sealing assemblies are known to the art. Even in view of the large number of sealing technologies already available, additional technologies are continually sought. The need for such additional technologies is sometimes related to convenience; reliability; changing well dynamics due to changing well parameters and changing production methods and technologies, for example. The art will therefore be well receptive to new and useful sealing technologies.

### SUMMARY

A seal assembly including a seal body; an augmentation configuration partially radially displaced from the seal body; a filler material at least partially disposed between the seal body and the augmentation configuration.

A method for sealing an annular space including running a seal assembly to depth having: a seal body; an augmentation configuration partially radially displaced from the seal body; a filler material at least partially disposed between the seal body and the augmentation configuration; deploying the assembly; rupturing the augmentation configuration.

### BRIEF DESCRIPTION OF THE DRAWINGS

Referring now to the drawings wherein like elements are numbered alike in the several Figures:

FIG. 1 is a schematic view of an embodiment of a seal assembly as disclosed herein in a run-in position;

FIG. 2 is a schematic view of the seal assembly shown in FIG. 1 but in the set position;

FIG. 3 is a schematic view of an embodiment of a seal assembly as disclosed herein in a run-in position;

FIG. 4 is a schematic view of the seal assembly shown in FIG. 3 but in the set position;

FIG. 5 is a schematic view of an embodiment of a seal assembly as disclosed herein in a run-in position;

FIG. 6 is a schematic view of the seal assembly shown in FIG. 5 but in the set position; and

FIG. 7 is a schematic view of a surface of the augmentation configuration disclosed herein.

### DETAILED DESCRIPTION

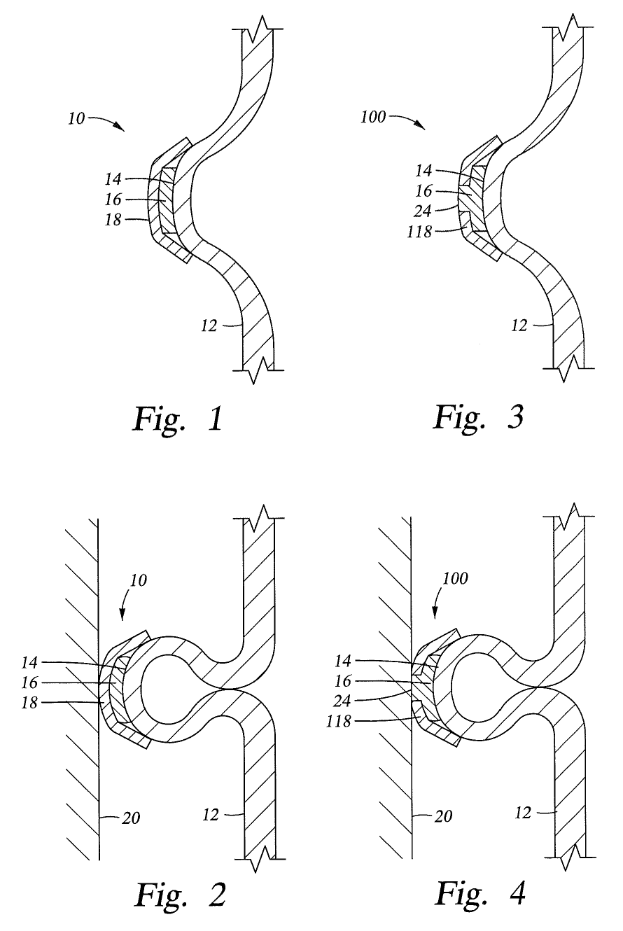

Referring to FIGS. 1 and 2, a seal assembly 10 is illustrated. The assembly 10 comprises a seal body 12 having a sealing surface 14. It is to be noted that while surface 14 is identified here to be radially outwardly located of the seal body 12 to seal against a tubular body radially outwardly disposed of the seal body 12, this surface and additional components of the seal assembly 10 described herein could be located on a radially inward surface (on an opposing surface to indicated surface 14) of the seal body 12 to allow for sealing to a structure radially inwardly disposed of the body 12. Accordingly, it is to be appreciated that the components discussed hereafter and illustrated in the drawings to be located upon a radially outward surface 14, can be located alternately to be on the radially inward surface of body 12.

In one embodiment, a filler material 16 is disposed adjacent sealing surface 14 and a seal augmenting configuration 18 is disposed at an opposite side of the filler material 16 from the body 12 so as to at least partially sandwich the filler material between the seal augmenting configuration 18 and the body 12. In such a configuration, the filler material 16 tends to energize the augmenting configuration 18 into contact with another structure 20 when the seal assembly is in a set position (see FIG. 2). The augmenting configuration is, in one embodiment a soft metal material such as copper or silver, for example. The soft metal material is bonded to the surface 14 of the body 12 using a magnetic pulse welding technique that facilitates an atomic bond between the materials. This is particularly useful when the materials of body 12 and configuration 18 are dissimilar. In one case, the material of body 12 is a nickel alloy or stainless steel, clearly dissimilar to copper or silver exemplified above. Because the bond created by the magnetic pulse welding process is atomic in nature, the bond will not break or allow separation of the materials in any way regardless of temperature, pressure, or other downhole wellbore condition. The process thus is well suited to the construction of the seal assembly disclosed herein. This is the case with each of the embodiments illustrated herein.

Still referring to the FIGS. 1 and 2 embodiments, the augmenting configuration is fully closed about the filler material 16. The material 16 is hence enclosed between the augmenting configuration 18, the body 12 and the bonded areas between the two. In such configuration the filler material 16 functions principally as an energizer as it does not physically contact the surface 20. Energization is beneficial as it reduces effects of changes in contact stress that are associated with thermal changes (expansion or contraction) or positional changes of the seal assembly, for example. Augmenting configuration 18, being a relatively soft material is pressed into smaller imperfections in the surface 20 to improve the sealing capability of the seal assembly 10.

In another embodiment of the seal assembly identified as 100 for clarity, referring to FIGS. 3 and 4, the seal body 12 and the filler material 16 are identical to the FIG. 1 embodiment but the augmenting configuration 118 is distinct in that it is configured as two halves of a ring. This configuration exposes a portion of the filler material 16 at gap 24 such that it is possible for the filler material to come into contact with the surface 20 when the assembly of FIG. 3 is set (see FIG. 4). Moreover, as can be appreciated in FIG. 4, the augmenting configuration 118 still contacts the surface 20 between a portion of the filler material 16 and that surface 20 so that the augmenting configuration is mechanically loaded against the surface 20 and accordingly still maintains the sealing function described with reference to FIG. 1. In addition to the sealing function, the augmenting configuration in FIG. 3 and 4 further plays a backup function for the filler material 16, now in contact with the surface 20 an thereby exposed. Such a filler material, which in one embodiment is Polyetheretherketone (PEEK) material, is soft enough to be extruded from its intended position by pressure imbalances experienced by the assembly in use. As such, the augmenting configuration provides service as a pair of backup rings to prevent extrusion.

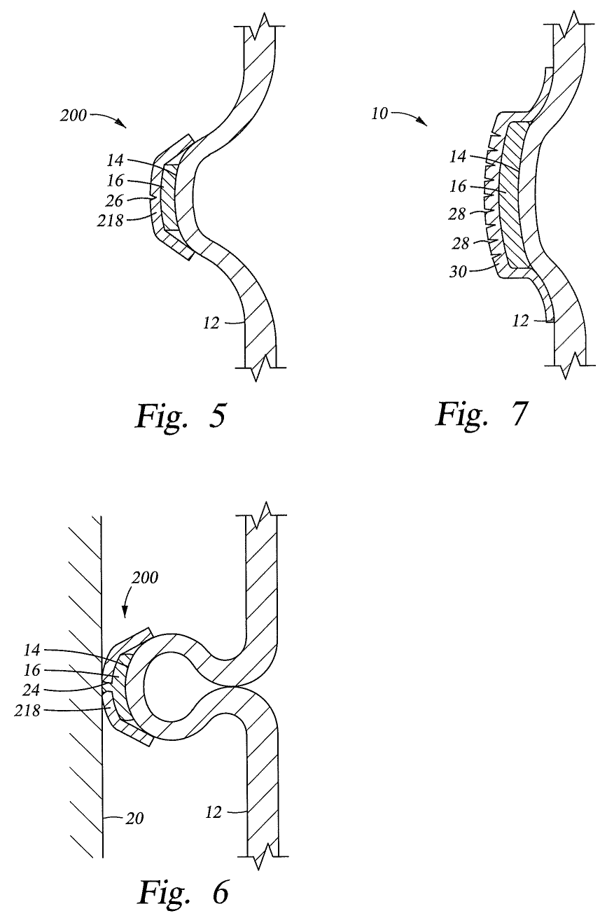

In a third illustrated embodiment of the seal assembly identified by numeral 200 for clarity, referring to FIGS. 5 and 6, the body 12 and filler material 16 are as they are described with reference to FIG. 1 but the augmenting configuration 218 is again distinct. In this embodiment, the augmenting configuration begins as a single ring of material having a line of weakness 26 therein. In the illustrations of FIGS. 5 and 6, the line of weakness is a groove formed in the material of augmentation configuration 218. The groove functions to thin the material of configuration 218 thereby predisposing it to rupture upon setting of the assembly. The line of weakness can also be created using material consistency, heat treatment, etc providing that the effect is that a line of relatively weaker material is created to facilitate the rupture of the augmentation configuration in the location desired. During setting of the seal assembly 200, it will be appreciated that the augmentation configuration is put into a position where a significant strain is imposed on the augmentation configuration axially, circumferentially and radially. This is because the diameter of the body 12, as illustrated in FIG. 6, is growing pursuant to the setting sequence. Because the line of weakness presents a lesser resistance to rupture than the material adjacent that line, the configuration 218 is apt to part at that location as noted above. This embodiment of the seal assembly disclosed herein provides for protection of the filler material 16 while running while at the same time takes advantage of the greater conformability of the filler material to seal smaller irregularities in the surface 20. The embodiment also presents a backup function for the filler material 16 at the two halves of the augmentation configuration 218 post rupture.

It is to be appreciate that any of the embodiments disclosed herein can be configured with one or more serrations 28 on an outer surface 30 of the augmentation configuration. Such a serrated surface configuration is illustrated schematically in FIG. 7. The serrations (one or more) are beneficial in retrieval of the assembly after setting. This is due to the ability of the material of the augmentation configuration ‘pull down” better because the excess material dimensions caused by stretching during setting has somewhere to go.

While preferred embodiments have been shown and described, modifications and substitutions may be made thereto without departing from the spirit and scope of the invention. Accordingly, it is to be understood that the present invention has been described by way of illustrations and not limitation.

1. A seal assembly comprising:
a seal body;
an augmentation configuration partially radially displaced from the seal body;
a filler material at least partially disposed between the seal body and the augmentation configuration.

2. A seal assembly as claimed in claim 1 wherein the augmentation configuration is atomically bonded to the seal body.

3. A seal assembly as claimed in claim 2 wherein the bond is a magnetic pulse weld.

3. A seal assembly as claimed in claim 1 wherein the augmentation configuration includes a line of weakness.

4. A seal assembly as claimed in claim 3 wherein the line of weakness is a groove.

5. A seal assembly as claimed in claim 1 wherein the augmentation configuration is a single piece ring.

6. A seal assembly as claimed in claim 1 wherein the augmentation configuration comprises more than one piece.

7. A seal assembly as claimed in claim 1 wherein the augmentation configuration is a two piece ring, each piece being bonded to the seal body.

8. A seal assembly as claimed in claim 7 wherein each piece of the two pieces contacts a sealing surface of another structure and backs up the filler material during use.

9. A seal assembly as claimed in claim 1 wherein the augmentation configuration includes one or more serrations.

10. A method for sealing an annular space comprising:
running a seal assembly to depth having: a seal body; an augmentation configuration partially radially displaced from the seal body; a filler material at least partially disposed between the seal body and the augmentation configuration;
deploying the assembly;
rupturing the augmentation configuration.

11. A method as claimed in claim 10 wherein the rupturing exposes the filer material.

12. A method as claimed in claim 10 wherein the sealing is accomplished by radially deforming the seal assembly.

13. A method as claimed in claim 10 wherein the method further comprises conforming the augmenting configuration to a surface of a separate structure.

14. A method as claimed in claim 10 wherein the method further comprises conforming the filler material to a surface of a separate material.

15. A method as claimed in claim 13 wherein the conforming further includes energizing the augmenting configuration with the filler material.

16. A method as claimed in claim 10 wherein the augmenting configuration backs up the filler material to mitigate extrusion thereof.
